(19) United States
(12) Patent Application Publication
(10) Pub. No.: US 2007/0191544 A1
(43) Pub. Date: Aug. 16, 2007

(54) Curable Composition Based on Polyurethane-Urea and on Block Copolymers, and Transparent Material Obtained From Said Composition

(75) Inventors: Boris Jaffrennou, Charenton-Le-Pont (FR); Noemie Lesartre, Charenton-le-Pont (FR); Francoise Mechin, Villeurbanne (FR); Jean-Pierre Pascault, Villeurbanne (FR)

Correspondence Address: OCCHIUTI ROHLICEK & TSAO, LLP, 10 FAWCETT STREET, CAMBRIDGE, MA, 02138, US

(73) Assignee: Essilor International (Compagnie Generale D Optique), Cedex (FR)

(21) Appl. No.: 11/623,460

(22) Filed: Jan. 16, 2007

(30) Foreign Application Priority Data
Jan. 20, 2006 (FR) FR0600551

(51) Int. Cl. C08L 63/00

(52) U.S. Cl. 525/117

(57) ABSTRACT

Curable composition comprising (a) a prepolymer of the polyurethane type and (b) an aromatic diamine, especially of formula (I), in an amount such that the ratio of the number of amine functional groups of the diamine of formula (I) to the number of isocyanate functional groups of the prepolymer (a) is between 0.92 and 0.98, and at least 5% by weight, relative to the total weight of (a), (b) and (c), of a polystyrene-block-polybutadiene-block-poly)methyl methacrylate) block copolymer; method of preparing such a composition and transparent optical material obtained by heat treatment of said composition.

The present invention relates to novel curable compositions based on polyols, polyisocyanates, diamines and block copolymers, to transparent finished materials obtained by reaction of these compositions, and to a method of preparing curable compositions and transparent finished materials. These materials are particularly useful for production of optical articles and more particularly ophthalmic articles.

There are two types of substrate generally used for the manufacture of optical articles, especially ophthalmic lenses, namely substrates made of a mineral glass and substrates made of an organic glass. At the present time, the market is developing very substantially in favour of organic glasses, which have the advantage of being lighter than mineral glasses and of being more impact-resistant. The organic glass substrates most used are a plastic polycarbonate and the polycarbonate obtained by polymerization of diethylene glycol bis(allyl carbonate).

In its research aimed at continually developing new high-performance materials for the manufacture of optical materials, the Applicant has found that polyurethane-urea-type materials are useful candidates for the manufacture of transparent materials that can be used for example to manufacture optical products, especially ophthalmic lenses. Polyurethane-ureas are polymers obtained by the polycondensation of polyols, polyisocyanates and diamines. For example, the reaction of oligodiols with diisocyanates results in the formation of soft polyurethane chains, whereas diamines form, by reaction with the diisocyanates, hard polyurea segments. When the polycondensation of these reactants is carried out under conditions for obtaining a large fraction of hard segments, material of high Young's modulus E is formed, consisting of a rigid matrix in which soft microdomains formed by the polyurethane chains are dispersed. The combination of polyurea hard segments and polyurethane soft segments gives the materials in question an excellent combination of particularly useful chemical and physical properties for optical, more specifically ophthalmic, applications.

Such materials are known to those skilled in the art. However, the handling of these products in liquid form, in which the state these compounds exist, is subject to constraints, these constraints are exerbated by the fact that isocyanates are toxic compounds requiring specific containment means for handling and storing them in liquid form. Finally, these products in the liquid state generally have a high reactivity, limiting the capability of storing them satisfactorily.

The reaction between an isocyanate functional group and an amine may be very rapid, of the order of one second, and the processing of polyurethane-ureas consequently requires the use of quite complex processes, such as RIM (reaction injection moulding) or RTM (resin transfer moulding). It may be beneficial to be able to process polyurethane-ureas by simpler processes, such as extrusion, injection moulding or coextrusion, and also to be able to have compositions for obtaining such polyurethane-ureas in solid form, which are easier to store, contain and process.

A useful approach for obtaining such polyurethane-urea materials is to incorporate block copolymers into these materials. The incorporation of such block copolymers into epoxide matrices is for example described in International Application WO 01/92415. Epoxy materials modified by the introduction of block copolymers retain their transparency, have improved mechanical properties and suffer only a small drop in their glass transition temperature Tg. Thus, the Applicant has formulated novel curable compositions based on polyols, polyisocyanates, amines and block copolymers that meet this requirement.

Consequently, one subject of the present invention is a curable composition comprising:
(a) a prepolymer of the polyurethane type, obtained by the polycondensation:
   1) of one or more polyisocyanates chosen from xylylene diisocyanate (XDI), meta-tetramethylxylene diisocyanate (TMXDI), cycloaliphatic diisocyanates, the trimer of isophorone diisocyanate, and the trimer of hexamethylene diisocyanate; and
   2) of one or more polyols chosen from the family of polypropoxylated bisphenol A compounds, containing an average 1 to 10 propylene oxide units on each side of the central bisphenol A group, the family of polyethoxylated bisphenol A compounds, containing on average 1 to 15 ethylene oxide units on each side of the central bisphenol group A, and the family of difunctional, trifunctional and tetrafunctional polycaprolactone-alcohols;
(b) an aromatic diamine chosen from diethyltoluene diamine (DETDA) or a diamine of formula (I): 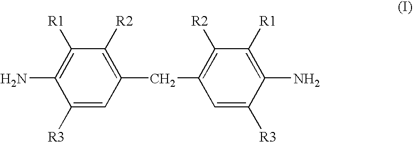
in which R1 and R3, which are identical or different, each represent, independently of one another, a group chosen from methyl, ethyl, n-propyl and isopropyl and R2 represents a hydrogen atom or a chlorine atom, in an amount such that the ratio of the number of amine functional groups of the diamine to the number of isocyanate functional groups of the prepolymer (a) is between 0.92 and 0.98; and
(c) at least 5% by weight, relative to the total weight of (a), (b) and (c), of a polystyrene-block polybutadiene-block-poly(methyl methacrylate) block copolymer (PS-b-PB-b-PMMA).

Such a composition, after heat-induced reaction, gives rise to a polyurethane-urea (PUU) material having a transparency allowing it to be used as optical material, for example for the manufacture of ophthalmic lenses.

Another subject of the present invention is consequently a transparent material obtained by heat-induced reaction of the above curable composition, and also an optical article, preferably an ophthalmic lens, comprising such a material.

In the present application, the definitions of certain terms must be understood as follows:
“optical article” is understood to mean optical lenses for instruments and for sight, visors and ophthalmic lenses, and also films of optical quality that can be used within an optical lens, visor or ophthalmic lens; and
“ophthalmic lens” is understood to mean lenses that may especially be fitted into a spectacle frame, with the function of protecting the eyes and/or correcting sight, these lenses being chosen from afocal, unifocal, bifocal, trifocal and progressive lenses.

Further subjects of the present invention are a method of preparing the curable composition and a method of preparing the polyurethane-urea material that will be described in greater detail below.

It is important in the present invention to prepare a curable composition containing a polyurethane prepolymer synthesized beforehand, that is to say before reaction with the diamine reactant. This is because the reactivity of isocyanate functional groups with respect to amine functional groups is considerably higher than that of isocyanate functional groups with respect to the alcohol functional groups of polyols, and the simultaneous contacting of the three reactants would result in the very rapid formation of long hard sequences of the polyurea type with very little, or even no, soft polyurethane sequences.

To form the polyurethane prepolymer by polycondensation, it is important to use a molar excess of polyisocyanates relative to polyols. It will be preferable to use 2 to 3 molar equivalents of polyisocyanate per mole of polyol. This molar ratio will leave, after the alcohol functional groups have completely reacted, a large fraction of isocyanate functional groups that have not reacted and which remain available for the reaction of polycondensation with the diamine.

According to a preferred embodiment, the curable composition according to the invention comprises:
(a) a prepolymer of the polyurethane-diisocyanate type obtained by the polycondensation of a cycloaliphatic diisocyanate with a polypropoxylated bisphenol A containing on average 1 to 10 propylene oxide (PO) units on each side of the bisphenol A group;
(b) an aromatic diamine of formula (I): 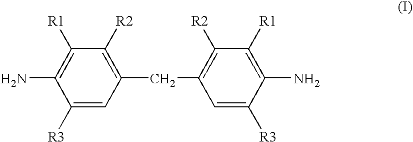
in which R1 and R3, which are identical or different, each represent, independently of one another, a group chosen from methyl, ethyl, n-propyl and isopropyl and R2 represents a hydrogen atom or a chlorine atom, in an amount such that the ratio of the number of amine functional groups of the diamine of formula (I) to the number of isocyanate functional groups of the prepolymer (a) is between 0.92 and 0.98; and
(c) 5% to 80% by weight, relative to the total weight of (a), (b) and (c), of a polystyrene-block-polybutadiene-block-poly(methyl methacrylate) block copolymer.

In a preferred embodiment of the invention, the isocyanate used is a cycloaliphatic diisocyanate. The preferred diisocyanate for preparing the polyurethane-urea materials of the present invention is isophorone diisocyanate (IPDI).

Diamines of formula (I) are preferred within the context of the invention.

The particularly preferred diamine of formula (I) is 4,4′-methylene-bis[3-chloro-2,6-diethylaniline] (MCDEA).

In the present invention, it will be preferable, for preparing the polyurethane prepolymer, to use one or more polyols chosen from the family of polypropoxylated bisphenol A compounds containing on average 3.5 to 8 propylene oxide units on each side of the central bisphenol A group and the family of polyethoxylated bisphenol A compounds containing on average 3 to 6 ethylene oxide units on each side of the central bisphenol A group. Within the context of the invention, it will be particularly advantageous to use a polypropoxylated bisphenol A containing on average 3.3, 5.5 or 7.5 propylene oxide units on each side of the central bisphenol A group, called hereafter 3.5PO-BPA, 5.5PO-BPA and 7.5PO-BPA, respectively.

It is also important to use in the curable composition of the present invention a molar ratio of the number of amine functional groups to the number of isocyanate functional groups close to 1, but slightly less than this value. This is because having these two types of functional groups in almost stoichiometric proportions ensures a degree of polymerization sufficient for obtaining a material of high molecular weight and of high glass transition temperature, especially one that can be used for the manufacture of ophthalmic lenses. However, the number of amine functional groups must be less that the number of isocyanate functional groups in order to ensure that the cured final material contains no free amine functional groups, which would result in progressive yellowing of the cured transparent material over the course of time.

The ratio of the number of amine functional groups of the diamine of formula (I) to the number of isocyanate functional groups of the prepolymer (a) is thus preferably between 0.93 and 0.97, more preferably between 0.94 and 0.96 and particularly about 0.95.

The curable composition of the present invention preferably contains from 30 to 80% by weight, preferably 40 to 60% by weight and particularly about 50% by weight of a polystyrene-block-polybutadiene-block-poly(methyl methacrylate) block copolymer (PS-b-PB-b-PMMA) relative to the total mass of (a), (b) and (c). This amount makes it possible to improve the physical, and especially mechanical, properties of the material obtained from this curable composition.

The block copolymers that can be used within the context of the invention are for example described in Patent Applications WO 2005/073314 and WO 2005/014699. The reader may particularly refer to these documents for a detailed description of the PS, PB and PMMA parts of these block copolymers.

Finally, it is important for obtaining transparent polyurethane-urea materials for the poly(methyl methacrylate)(PMMA) block of the block copolymer to represent a large fraction of the block copolymer. According to an advantageous embodiment of the invention, the PMMA block preferably represent from 50% to 80% by weight, more preferably 55% to 75% by weight and in particular 60 to 70% by weight of the weight-average molecular weight of the polystyrene-block-polybutadiene-block-poly(methyl methacrylate) block copolymer.

For similar reasons, the weight-average molecular weight of said polymethyl methacrylate block is preferably between 10 000 and 100 000 g/mol for an overall weight-average molecular weight of the block copolymer of preferably between 15 000 and 200 000 g/mol.

Within the context of the invention, it should be understood that the block copolymers used may be a blend of a tribloc copolymer and a dibloc copolymer of the polystyrene-block-polybutadiene type. These copolymers are for example described in Patent Application WO 2005/073314.

The polyurethane-urea materials obtained from the curable compositions described above have a transparency suitable for use in the optics field and in particular in the ophthalmic field. This transparency is due to the nanostructuring of the material by the block copolymers, resulting in the formation of nanodomains containing at least the PMMA block of said tribloc copolymer. These nanodomains advantageously have a size between 10 and 80 nm, in particular between 20 and 60 nm.

The crack propogation resistance of the polyurethane-urea materials is significantly improved over the corresponding polyurethane-urea materials containing no block copolymers. Thus, the critical stress intensity factor K_{IC} (in MPa·m^{1/2}), measured according to the ASTM E399 or ASTM E 1820 standards on precracked standardized specimens, is generally at least 10% higher than that of the corresponding PUU material containing no block copolymer.

The critical stress intensity factor K_{IC} (in MPa·m^{1/2}) of the polyurethane-urea materials according to the invention is generally greater than 1.45 MPa·m^{1/2}, preferably greater than 1.50 MPa·m^{1/2} and in particular greater than 1.55 MPa·m^{1/2}.

To improve certain properties of the optical products manufactured from the curable compositions of the present invention, for example the impact strength, the abrasion and scratch resistance, the antireflection character and the resistance to soiling, it is possible to form one or more functional coatings on at least one of the principal surfaces. Thus, it is very possible to form, in succession, on one principal face of the optical article of polyurethane according to the invention, a first coating, called an impact-resistant primer, the function of which is to increase the impact strength of the article but also the adhesion of subsequent coatings to the substrate, then, on this impact-resistant primer coating, a hard coating, generally called an abrasion-resistant or scratch-resistant coating, the purpose of which is to improve the capability of the surface of the optical article to be resistant to damage due to mechanical abuse. It is also possible to superimpose, on the abrasion-resistant coating, an antireflection coating on which may optionally be superimposed an anti-soiling coating, the purpose of which is to modify the interfacial tension between the antireflection layer and water of grease, but also to close off interstices so as to prevent grease from infiltrating and remaining therein. The optical article may also include an antistatic coating.

As indicated above, another subject of the invention is a method of preparing a curable composition as described above, comprising:

1. the preparation of a first component (A) by blending:
a prepolymer of the polyurethane type, obtained by the polycondensation:
   1) of one or more polyisocyanates chosen from xylylene diisocyanate (XDI), meta-tetramethylxylene diisocyanate (TMXDI), cycloaliphatic diisocyanates, the trimer of isophorone diisocyanate, and the trimer of hexamethylene diisocyanate; and
   2) of one or more polyols chosen from the family of polypropoxylated bisphenol A compounds, containing on average 1 to 10 propylene oxide units on each side of the central bisphenol A group, the family of polyethoxylated bisphenol A compounds, containing on average 1 to 15 ethylene oxide units on each side of the central bisphenol group A, and the family of difunctional, trifunctional and tetrafunctional polycaprolactone-alcohols.
      the isocyanate functional groups being present in excess relative to the alcohol functional groups;
with a polystyrene-block-polybutadiene-block-poly(methyl methacrylate) block copolymer, the weight ratio of the prepolymer to the block copolymer being between 95/5 and 20/80;

2. the preparation of a second compound (B) by blending:
a diamine chosen from diethyltoluene diamine (DETDA) or a diamine of formula (I): 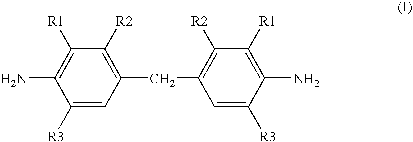
in which R1 and R3, which are identical or different, each represent, independently of one another, a group chosen from methyl, ethyl, n-propyl and isopropyl and R2 represents a hydrogen atom or a chlorine atom,
with a polystyrene-block-polybutadiene-block-poly(methyl methacrylate) block copolymer, the weight ratio of the amine to the block copolymer being between 95/5 and 20/80; and then

3. the blending of the first component (A) with the second component (B) in respective amounts such that the ratio of the number of amine functional groups of the diamine to the number of isocyanate functional groups of the prepolymer is between 0.92 and 0.98. Of course, all of the abovementioned preferences with regard to the curable composition apply to the technical characteristics of the method of preparing it.

The preparation of such a curable composition is particularly facilitated by its processing options. Thus, the preparation of the first composition (A) and the preparation of the second composition (B) by blending their respective components are carried out separately and independently, preferably by extrusion in an extruder, preferably a twin-screw extruder, at maximum temperatures ranging between 100° C. and 150° C. This extrusion is preferably followed by granulation of the extruded rods on exiting the die. The granules may be easily stored. Thanks to the method for processing the curable composition according to the invention, it is therefore possible to obtain, and to store under ambient temperature conditions, the two precursor components of the finished polyurethane-urea material independently and in a chemically stable manner.

The granules thus obtained may then be introduced in the appropriate proportions of (A) and (B) into an extruder, preferably a twin-screw extruder, at a maximum temperature between 120 and 140° C., preferably at a temperature between 125 and 135° C.

The extruded curable composition thus obtained therefore results in an intermediate curable composition in the form of a reactive compound. By storing this reactive compound at a temperature below room temperature the physico-chemical and mechanical properties thereof are stable. This intermediate curable composition may thus be stored in the form of granules or as film, depending on the geometry of the die used at the extruder exit.

In another variant, the two precursor components (A) and (B) of the finished polyurethane-urea material that are obtained in the form of independent granules as described above may be coextruded. In such a configuration of the method, what is obtained is an intermediate curable composition in the form of granules or film from which there is no intimate mixing between the reactive functional groups of the first component (A) and the reactive functional groups of the second component (B), but only an interface or interphase between these two components. Such a curable composition is stable and can be easily stored at room temperature. It may also be used as such, especially if it is in the form of a film.

The extruded or coextruded curable composition thus obtained can then be processed, for example by moulding, injection moulding or thermoforming, and exposed to a temperature between 100° C. and 170° C. for a time of between 1 hour and 15 hours so as to give a transparent cured material according to the present invention.

According to a preferred variant of the invention, the first composition (A) in the form of granules and the second composition (B) in the form of granules are blended in stoichiometric (or almost stoichiometric) proportions, poured into the hopper of an injection moulding machine and then injected into a mould. The thermal curing within the mould of the injection moulding machine results in a product comprising a transparent polyurethane-urea material based on a curable composition according to the invention. The mould of the injection moulding machine is advantageously an ophthalmic lens insert, thus making it possible to obtain ophthalmic lenses.

The invention will now be illustrated with the aid of an example according to the invention.

### EXAMPLE 1

An [IPDI/7.5PO-BPA] prepolymer (with NCO/OH=3/1) was bulk-synthesized in a jacketed glass reactor at 110° C. for 12 hours in an inert atmosphere (argon). The amounts of each of the monomers incorporated in the reactor were the following:
m_{IPDI}=563.8 g (37.5%)
m_{7.5PO-BPA}=939.5 g 62.5%).

Comparison between the theoretical and experimental values obtained by a chemical assay of the isocyanate functional groups confirmed that the reaction of forming the prepolymer was complete after this period of time. In addition, the isocyanate equivalent no longer changed as the function of time after 12 h: [symbol]
theoretical Eq_{NCO} (prepolymer)*=2.24 mol of NCO function groups/kg prepolymer: [symbol]
experimental Eq_{NCO} (prepolymer)=2.18 (±0.04) mol of NCO functional groups/kg prepolymer.

*The theoretical NCO equivalent was calculated from the molecular weights of the products (alcohol and isocyanate) determined by chemical assay (using the NF T52-112 and NF T52-132 standards respectively).

The block copolymer used in this example was a PS-b-PB-b-PMMA with a weight-average molecular rate of 41 900 g/mol with a mass fraction of PMMA block of greater than 50%.

Two rods, of prepolymer/PS-b-PB-b-PMMA and MCDEA/PS-b-PB-b-PMMA, were extruded separately and then granulated on exiting the die. The prepolymer/PS-b-PB-b-PMMA and MCDEA/PS-b-PB-b-PMMA granules were prepared using a Clextral BC21 corotating twin-screw extruder. The screw speed was set at 200 rpm.

Since both the PS-b-PB-b-PMMA and MCDEA were in powder form, the two powders were dry blended in an amount of 50% by weight of each. The powder blend was poured into the hopper at a rate of 2 kg/h using a K-Tron EDDER pump from Division Instruments. The extrusion was carried out at a maximum temperature of 110° C. The rod obtained on exiting the die was then granulated.

The prepolymer was in the form of a viscous liquid at room temperature. It was poured into the hopper directly onto the screws at 110° C. using a Pumpdrive 5001 peristatic pump (from Heidolph) at a rate of 1 kg/h. The PS-b-PB-b-PMMA was incorporated in the hopper at a rate of 1 kg/h using the same pump as above, so as to process prepolymer/PS-b-PB-b-PMMA blends with an amount of 50% by weight of each of the products. The rod was then granulated on exiting the die. Chemical assay of the isocyanate functional groups in the prepolymer/SMB granules confirmed the flow rate uniformity of the two pumps. The values obtained indicated that the NCO functional groups suffered no (or very little) degradation during extrusion and that the product formed over the entire length of the operation was relatively uniform (little disparity in the measurements carried out on granules taken at different times during the operation): [symbol]
experimental Eq_{NCO} (propolymer/PS-b-PB-b-PMMA granules)=1.05 (±0.1) mol of NCO functional groups/kg of granules.

Thus, two batches of macroscopically uniform prepolymer/PS-b-PB-b-PMMA and MCDEA/PS-b-PB-b-PMMA granules were obtained.

The two types of granules were blended in solid form with an NH₂/NCO ratio=0.95, according to the isocyanate equivalent determined by chemical assay of the isocyanate/PS-b-PB-b-PMMA granules and the amine equivalent calculated from the molar mass of MCDEA (50/50 MCDEA/PS-b-PB-b-PMMA blend). The masses of the blended granules were the following:
M_{prepolymer/PS-b-PB-b-PMMA granules}=1812.8 g
m_{MCDEA/PS-b-PB-b-PMMA granules}=687.1 g.

The blend was extruded in a twin-screw extruder at a maximum temperature of 130° C.

The product obtained was perfectly transparent and had satisfactory mechanical properties (impact strength, crack propagation resistance) in order to be able to be used as optical material, in particular for the manufacture of ophthalmic lenses.

1. Curable composition comprising:
(a) a prepolymer of the polyurethane type, obtained by the polycondensation:
1) of one or more polyisocyanates chosen from xylylene diisocyanate (XDI), meta-tetramethylxylene diisocyanate (TMXDI), cycloaliphatic diisocyanates, the trimer of isophorone diisocyanate, and the trimer of hexamethylene diisocyanate; and
2) of one or more polyols chosen from the family of polypropoxylated bisphenol A compounds, containing on average 1 to 10 propylene oxide units on each of the central bisphenol A group, the family of polyethoxylated bisphenol A compounds, containing on average 1 to 15 ethylene oxide units on each side of the central bisphenol group A, and the family of difunctional, trifunctional and tetrafunctional polycaprolactone-alcohols
(b) an aromatic diamine chosen from diethyltoluene diamine (DETDA) or a diamine of formula (I): 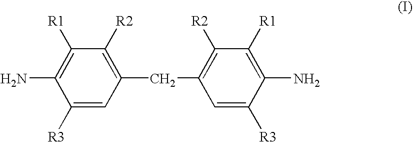
in which R1 and R3, which are identical or different, each represent, independently of one another, a group chosen from methyl, ethyl, n-propyl and isopropyl and R2 represents a hydrogen atom or a chlorine atom,
in an amount such that the ratio of the number of amine functional groups of the diamine of formula (I) to the number of isocyanate functional groups of the prepolymer (a) is between 0.92 and 0.98; and
(c) at least 5% by weight, relative to the total weight (a), (b) and (c), of a polystyrene-block-polybutadiene-block-poly(methyl methacrylate) block copolymer (PS-b-PB-b-PMMA).

2. Curable composition according according to claim 1, characterized in that it comprises one or more polyols chosen from polypropoxylated bisphenol A compounds containing on average 3.5 to 8 propylene oxide units on each side of the central bisphenol A group and the family of polyethoxylated bisphenol A compounds containing on average 3 to 6 ethylene oxide units on each side of the central bisphenol A group.

3. Curable composition according to claim 1, characterized in that it comprises:
(a) a prepolymer of the polyurethane-diisocyanate type obtained by the polycondensation of a cycloaliphatic diisocyanate with a polypropoxylated bisphenol A containing on average 1 to 10 propylene oxide (PO) units on each side of the central bisphenol A group;
(b) an aromatic diamine of formula (I): 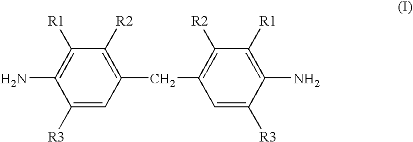
in which R1 and R3, which are identical or different, each represent, independently of one another, a group chosen from methyl, ethyl, n-propyl and isopropyl and R2 represents a hydrogen atom or a chlorine atom,
in an amount such that the ratio of the number of amine functional groups of the diamine of formula (I) to the number of isocyanate functional groups of the prepolymer (a) is between 0.92 and 0.98; and
(c) 5% to 80% by weight, relative to the total weight of (a), (b) and (c), of a polystyrene-block-polybutadiene-block-poly(methyl methacrylate) block copolymer.

4. Curable composition according to claim 1, characterized in that it comprises a polypropoxylated bisphenol A containing on average 3.5, 5.5 or 7.5 propylene oxide units on each side of the central bisphenol A group.

5. Curable composition according to claim 1, characterized in that it comprises 2 to 3 molar equivalents of polyisocyanate per mole of polyol.

6. Curable composition according to claim 1, characterized in that the polyisocyanate is a cycloaliphatic diisocyanate.

7. Curable composition according to claim 6, characterized in that the polyisocyanate is isophorone diisocyanate (IPDI).

8. Curable composition according to claim 1, characterized in that the diamine is a diamine of formula (I).

9. Curable composition according to claim 8, characterized in that the diamine is 4,4′-methylene-bis[3-chloro-2,6-diethylaniline].

10. Curable composition according to claim 8, characterized in that the ratio of the number of amine functional groups of the diamine of formula (I) to the number of isocyanate functional groups of the prepolymer (a) is between 0.93 and 0.97, more preferably between 0.94 and 0.96 and particularly about 0.95.

11. Curable composition according to claim 1, characterized in that it comprises 30 to 80% by weight, preferably 40 to 60% by weight and particularly about 50% by weight of a polystyrene-block-polybutadiene-block-poly(methyl methacrylate) block copolymer (PS-b-PB-b-PMMA) relative to the total mass of (a), (b) and (c).

12. Curable composition according to claim 1, characterized in that the PMMA block represents from 50% to 80% by weight, preferably 55% to 75% by weight and in particular 60 to 70% by of the weight-average molecular weight of the polystyrene-block-polybutadiene-block-poly(methyl methacrylate) block copolymer.

13. Curable composition according to claim 12, characterized in that the weight-average molecular weight of said polymethyl methacrylate block is preferably between 10 000 and 100 000.

14. Curable composition according to claim 1, characterized in that the structuring of the material by the block copolymers results in the formation of nanodomains having a size of between 10 and 80 nm, in particular between 20 and 60 nm.

15. Transparent cured material obtained by thermal curing of the curable composition according to claim 1.

16. Transparent cured material according to claim 15, characterized in that it has a crack propagation resistance, expressed by the critical intensity factor K_{IC} (in MPa·m^{1/2}), of greater than 1.45 MPa·m^{1/2}, preferably greater than 1.50 MPa·m^{1/2} and in particular greater than 1.55 MPa·m^{1/2}.

17. Optical article comprising a transparent cured material according to claim 15.

18. Optical article according to claim 17, characterized in that it is an ophthalmic lens.

19. Method of preparing a curable composition, comprising the following steps:
1. the preparation of a first component (A) by blending:
a prepolymer of the polyurethane type, obtained by the polycondensation:
of one or more polyisocyanates chosen from xylylene diisocyanate (XDI), meta-tetramethylxylene diisocyanate (TMXDI), cycloaliphatic diisocyanates, the trimer of isophorone diisocyanate, and the trimer of hexamethylene diisocyanate; and
of one or more polyols chosen from the family of polypropoxylated bisphenol A compounds, containing on average 1 to 10 propylene oxide units on each side of the central bisphenol A group, the family of polyethoxylated bisphenol A compounds, containing on average 1 to 15 ethylene oxide units on each side of the central bisphenol group A, and the family of difunctional, trifunctional and tetrafunctional polycaprolactone-alcohols,
the isocyanate functional groups being present in excess relative to the alcohol functional groups;
with a polystyrene-block-polybutadiene-block-poly(methyl methacrylate) block copolymer, the weight ratio of the prepolymer to the block copolymer being between 95/5 and 20/80;
2. the preparation of a second compound (B) by blending:
a diamine chosen from diethyltoluene diamine (DETDA) or a diamine of formula (I): 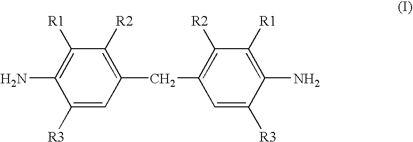
in which R1 and R3, which are identical or different, each represent, independently of one another, a group chosen from methyl, ethyl, n-propyl and isopropyl and R2 represents a hydrogen atom or a chlorine atom,
with a polystyrene-block-polybutadiene-block-poly(methyl methacrylate) block copolymer, the weight ratio of the amine to the block copolymer being between 95/5 and 20/80; and then
3. the blending of the first component (A) with the second component (B) in respective amounts such that the ratio of the number of amine functional groups of the diamine to the number of isocyanate functional groups of the prepolymer is between 0.92 and 0.98.

20. Curable composition according to claim 9, characterized in that the ratio of the number of amine functional groups of the diamine of formula (I) to the number of isocyanate functional groups of the prepolymer (a) is between 0.93 and 0.97, more preferably between 0.94 and 0.96 and particularly about 0.95.

21. Optical article comprising a transparent cured material according to claim 15.
